(19) United States
(12) Patent Application Publication
(10) Pub. No.: US 2008/0023920 A1
(43) Pub. Date: Jan. 31, 2008

(54) Encoder-equipped sealing device

(76) Inventor: Masanori Tomioka, Okayama (JP)

Correspondence Address: WENDEROTH, LIND & PONACK, L.L.P., 2033 K STREET N. W., SUITE 800, WASHINGTON, DC, 20006-1021, US

(21) Appl. No.: 11/822,860

(22) Filed: Jul. 10, 2007

Related U.S. Application Data
(63) Continuation of application No. 11/391,217, filed on Mar. 29, 2006, now abandoned.
Application No. 11/391,217 is a continuation of application No. 10/776,261, filed on Feb. 12, 2004, now abandoned.

(30) Foreign Application Priority Data
Feb. 12, 2003 (JP) 2003-033050

(51) Int. Cl. F16J 15/32

(52) U.S. Cl. 277/549

(57) ABSTRACT

A sealing device has an encoder incorporated therein, and includes a combination of seal elements (3, 2), each of which includes an annular metal core (31, 21) having a substantially L-shaped cross section having a cylindrical portion (31a, 21a) and a flange portion (31b, 21b) provided on one end of the cylindrical portion (31a, 21a) and extending in the direction perpendicular to the direction in which the cylindrical portion (31a, 21a) extends. A first seal element (3) of the two seal elements (3, 2) and the second seal element (2) are combined together such that the space defined by the cylindrical portion (31a) and flange portion (31b) of the first seal element (3) and the space defined by the cylindrical portion (21a) and flange portion (31b) of the second seal element (2) face each other. The first seal element (3) further includes an elastic seal portion (6) provided on the flange portion (31b) and disposed in the space defined by the cylindrical portion (31a) and flange portion (31b), and the second seal element (2) further includes a magnet-based encoder (1) provided on the flange portion (21b). A coating layer (8, 7) is provided on the side (31c) of the first seal element (3) opposite the side on which the first seal element (3) is combined with (faces) the second seal element (2), or on the side (1a) of the second seal element (2) opposite the side on which the second seal element (2) is combined with (faces) the first seal element (3), or on both of the sides (31c) and (1a).

This application is a continuation of U.S. application Ser. No. 11/391,217, filed Mar. 29, 2006, now pending, which is a continuation of U.S. application Ser. No. 10/776,261, filed Feb. 12, 2004, now abandoned.

### BACKGROUND

1. Field of the Invention

The present invention relates to an improvement to and/or in the encoder-equipped sealing device or sealing device that has a magnet-based encoder incorporated therein. More particularly, the present invention relates to such encoder-equipped sealing device that provides the capabilities for preventing the physical cohesion by the magnetic attraction from occurring between two or more units of the encoder-based sealing device that are adjacent to each other, when those units are placed one over another so that those units are oriented in one particular direction.

2. Description of the Prior Art

The encoder (pulse coder) that is incorporated in the encoder-equipped sealing device that has been described above takes the form of a pulse generator ring that may be mounted on an automotive vehicle in order to flexibly control the systems that ensure that the vehicle can be running with safety and stability, such as the anti-lock braking system (ABS), traction control system (TCS) and stability control system (SCS). This encoder may be mounted on the hub flange in the suspension system together with a sensor, and is used to detect the number of revolutions for each of the vehicle wheels. The encoder is mounted on each of the four wheels, such as front, rear, right and left wheels, together with the sensor, and may be used to detect any difference in the number of revolutions between each of the wheels. In response to such difference, the encoder may be activated to turn the drive system or brake system on and off, thereby controlling the behavior of the vehicle to ensure that the vehicle can be running with stability and safety in case some emergency situations should occur.

Lubrication oils may leak from the bearing units on the automotive vehicle on which the safety running control systems are installed as described above, and seals are required to avoid such leaks. Most of the sealing devices include integrated sealing and rotations detecting capabilities, and may be mounted on the gap or space that is available on the bearing units in order to meet such needs.

Typically, the sealing device that has been proposed for those recent years provides the rotations detecting function as well as an encoder function, and has been used widely for the practical purposes.

The typical encoder-equipped sealing device that has been proposed and practically used will be described below by referring to FIG. 5.

Two units 41, 42 of the encoder-equipped sealing device are shown in FIG. 5, in which each of the units includes two seal elements 3, 2 combined together.

Specifically, each seal element 3 includes a metal core 31 having a substantially L-shaped cross section wherein the metal core 31 has a cylindrical portion 31a and a flange portion 31b extending from one end of the cylindrical portion 31a in the direction perpendicular to the direction in which the cylindrical portion 31a extends. The seal element 3 further includes an elastic seal portion 6 on the flange portion 31b that is arranged in the space defined by the cylindrical portion 31a and flange portion 31b.

Similarly to the seal element 3, the seal element 2 also includes a metal core 21 having a substantially L-shaped cross section wherein the metal core 21 has a cylindrical portion 21a and a flange portion 21b extending from one end of the cylindrical portion 21a in the direction perpendicular to the direction in which the cylindrical portion 21a extends. The seal element 2 further includes a magnet-based encoder 1 that is provided on the flange portion 21b.

It may be seen from FIG. 5 that for each of the units 41, 42, the seal element 3 and seal element 2 are combined such that the space defined by the cylindrical portion 31a and flange portion 31b of the seal element 3 and the space defined by the cylindrical portion 21a and flange portion 21b of the seal element 2 face opposite each other.

The encoder-equipped sealing device that includes the combined seal elements 3 and 2 may be mounted on any area on the automotive vehicle that needs to be sealed, such as the appropriate area in the bearing unit as indicated by A in FIG. 1, and a sensor in FIG. I may be mounted adjacently to the encoder 1 so that it can face opposite the encoder 1. It may be seen from FIG. 5 that in the unit 41, for example, the seal element 2 including the encoder 1 may be mounted on a rotational element, such as the inner or outer race of the bearing unit, wherein the pulses that are magnetically generated by the encoder 1 may be detected by the sensor.

All individual units of the encoder-equipped sealing device that has been described above may be maintained in storage before they are actually used, such as being mounted on the areas of the bearing units on the automotive vehicle that need to be sealed, and each of the units has the seal elements 2, 3 completely assembled together. In storage, the individual units are maintained like a stack, as shown in FIG. 5, in which the units are placed one over another such that they can be oriented in one particular direction, for the convenience of the easy handling by the appropriate handling tools. It may be seen from FIG. 5 that two units 41, 42 of the encoder-equipped sealing device, for example, are placed one over the other in the horizontal direction such that each encoder 1 is located on the right side, and is oriented in one particular direction.

The plural units of the encoder-equipped sealing device that are placed one over the other such that they are oriented in one particular direction, as shown in FIG. 5, are loaded in a magazine, and they are transported or stored as they are placed one over another such that they are oriented in one particular direction in the magazine. When they are actually used, they may be removed from the respective magazines, and may then be mounted on the areas of the bearing unit that need to be sealed, such as those as shown by A in FIG. 1.

In the plural units of the encoder-equipped sealing device that are placed one over the other so that they are oriented in one particular direction as shown in FIG. 5, the encoder 1 in the unit 41, for example, produces a strong magnetic force that attracts the metal core 31 on the seal element 3 in the other unit 42 magnetically. When this magnetic attraction is coupled with the adhesiveness of the elastic material on which the encoder 1 is based (usually synthetic rubber or synthetic resin), it may cause cohesion to occur between the seal element 2 in the unit 41 and the seal element 3 in the other unit 42.

When such cohesion occurs, the two units may attract each other magnetically within the magazine, from which it is difficult to remove the units by using any appropriate fitting device for mounting the units on the area that needs to be sealed, such as the appropriate area in the bearing unit. This may cause the fitting device to become non-operational or may affect the working efficiency of the fitting device remarkably.

In another encoder-equipped sealing device that is proposed to address the problem described above, which is disclosed in Japanese patent application as published under No. 2001-141069, the seal portion is extended to provide a projection thereon. The purpose of providing this projection is to keep the two units of the encoder-equipped sealing device that are located adjacently to each other spaced away from each other. As this projection is formed as part of the elastic seal portion, the projection thus obtained is not sufficient to prevent the cohesion that occurs between the two units. It may be appreciated from the above description that the projection is also formed as an extension of the elastic material on which the seal portion is based, and the cohesion that occurs between the two units cannot be avoided because of the inherent adhesiveness of the elastic material that cannot be removed from the elastic material.

### SUMMARY OF THE INVENTION

In order to eliminate the serious disadvantages and problems associated with the prior art encoder-equipped sealing devices described above, it is an object of the present invention to provide an encoder-equipped sealing device that has a simple construction and prevents cohesion by the magnetic attraction that might otherwise occur between two units of the encoder-equipped sealing device that are located adjacent to each other. That is to say, the object of the present invention is to provide an encoder-equipped sealing device wherein individual units of the encoder-equipped sealing device can be removed from the magazine without being caught by each other, and then may be mounted securely on the area that needs to be sealed, such as the appropriate area in the bearing unit, even if those units of the encoder-equipped sealing device are placed one over the other such that they are oriented in one particular direction, and loaded in a magazine.

The problems mentioned above may be solved by providing the encoder-equipped sealing device in accordance with the present invention that is constructed as described below.

The encoder-equipped sealing device that is proposed by the present invention comprises two seal elements 3, 2 combined together, wherein each of the elements 3, 2 includes a metal core 31, 21 having a substantially L-shaped cross section, each of the metal cores 31, 21 having a cylindrical portion 31a, 21a and a flange portion 31b, 21b provided on one end of the cylindrical portion 31a, 21a and extending in the direction perpendicular to the direction in which the cylindrical portion 31a, 21a extends.

One seal element 3 and the other seal element 2 are combined together such that the space defined by the cylindrical portion 31a and flange portion 31b of the first seal element 3 and the space defined by the cylindrical portion 21a and flange portion 21b of the second seal element 2 face each other.

The first seal element 3 further includes an elastic seal portion 6 on the flange portion 31b that is arranged in the space defined by its cylindrical portion 31a and flange portion 31b, and the other seal element 2 further includes a magnet-based encoder 1 on the flange portion 21b.

In the encoder-equipped sealing device that has been described so far, the present invention proposes to provide an encoder-equipped sealing device that further includes a coating layer 8, 7 that may be provided on the side 31c of the first seal element 3 opposite the side on which the first seal element 3 is combined with the second seal element 2 (i.e., opposite the side facing the second seal element 2), or on the side 1a of the second seal element 2 opposite the side on which the second seal element 2 is combined with the first seal element 3 (i.e., opposite the side facing the first seal element 3), or on both of the sides 31c and 1a.

FIG. 2 represents a particular embodiment of the encoder-equipped sealing device 51, wherein a coating layer 8, 7 is provided on the side 31c of the first seal element 3 opposite the side on which the one seal element 3 is combined with the second seal element 2, or on the side 1a of the second seal element 2 opposite the side on which the other seal element 2 is combined with the first seal element 3, or on both of the sides 31c and 1a.

FIG. 4 shows that several units of such encoder-equipped sealing device 51 are placed one over another and adjacent to each other so that they can be oriented in a particular direction. In FIG. 4, two units 51 and 52 are shown, for example, in which one unit 51 is placed on the left side, and the other unit 52 is placed on the right side.

In the encoder-equipped sealing device according to the embodiment shown in FIG. 4, the two units 51, 52 are placed such that the encoder 1 in the first unit 51 can make contact with the seal element 3 in the second unit 52 through the intermediary of the coating layer 8, 7 interposed therebetween.

When the two units are placed as described above, the metal core 31 in the seal element 3 on the second unit 52 may be attached to the encoder 1 on the first unit 51 by the magnetic attraction of the encoder 1. When this happens, the unit 51 can be detached from the unit 52 easily by simply sliding either of the encoder 1 or metal core 31 relative to the other in the horizontal direction. Furthermore, it may be appreciated that the cohesion between the seal element 2 in the unit 51 and the seal element 3 in the unit 52 that would be caused by the magnetic attraction coupled with the adhesiveness of the elastic material on which the encoder 1 is based can be prevented by the presence of the coating layer 8, 7 interposed between the encoder 1 and seal element 3.

The above effect may be attained by providing a coating layer on either of the side 31c of the seal element 3 opposite the side on which the seal element 3 is combined with (faces) the seal element 2, or the side 1a of the seal element 2 opposite the side on which the seal element 2 is combined with (faces) the seal element 3. It may be seen from FIG. 2 and FIG. 4 that a coating layer 7, 8 may be provided on each of the sides 31c and 1a, respectively. This may serve to prevent the cohesion more effectively.

In the encoder-equipped sealing device according to the present invention, it should be noted that the coating layer 7, 8 may be formed as a lubricating layer having a lubricating surface. Thus, when several units of the encoder-equipped sealing device, such as two units 51, 52 as shown in FIG. 4, are placed one over another such that they can be oriented in one particular direction, those units can be separated from each other easily by simply sliding either of the encoder 1 in the unit 51 or the metal core 31 in the unit relative to the other in the horizontal direction.

The coating layer 7, 8 may be formed by using a suitable surface treatment liquid that contains a mixture composed of any suitable solvent and any material(s) selected from the group consisting of silicone oil, surface-active agent, wax, and metallic soap.

It may be understood that the purpose of using any of the silicone oil, surface-active agent, wax, and metallic soap is to provide the lubricating surface for the coating layer 7, 8 when the coating layer 7, 8 is formed.

Any type of the silicone oil, surface-active agent, wax or metallic soap may be employed as long as it can provide the lubricating surface for the coating layer 7, 8 when it is formed.

Examples of waxes that may be used for the above purpose include any substances that belong to the paraffin group or ethylene group. Any of such substances may be mixed with any suitable solvent so that it can be diffused evenly in the solvent. Examples of metallic soap may include such substances as potassium stearate, sodium stearate, calcium stearate and the like. Any of such substances may be mixed with any suitable solvent so that it can be diffused evenly in the solvent.

In the encoder-equipped sealing device according to the present invention, the seal portion 6 may be molded into the appropriate shape from any of the elastic materials such as synthetic rubber, synthetic resin and the like, and the metal core 21, 31 may be molded into the appropriate annular shape from iron, stainless steel or the like, similarly to the prior art encoder-equipped sealing device that has been described in the section “Prior Art”. Similarly, the encoder 1 may be molded into the appropriate shape from a mixture composed of any of the elastic materials such as synthetic rubber or synthetic resin and any of the ferromagnetic materials in its powdery forms such as ferrite, rare earth elements and the like.

The solvent that may be used as a component of the surface treatment liquid includes any type of solvent that will not erode the elastic material, iron and stainless steel, and is capable of dissolving the silicone oil, surface-active agent, wax and metallic soap, thereby providing a mixture (solution) that contains the uniformly diffused silicone oil, etc. One example of such type of solvent is an organic solvent such as chlorofluorosolvate.

The coating layer 8, 7 on the side 31c of the seal element 3 opposite the side on which the seal element 3 is combined with (faces) the seal element 2 and/or the side 1a of the seal element 2 opposite the side on which the seal element 2 is combined with (faces) the seal element 3 may be provided by brushing, rolling or spraying the surface treatment liquid onto the appropriate side and/or sides.

It should be noted that the dipping process may be employed to dip the seal elements 2, 3 within the surface treatment liquid, thereby forming the coating layer 8, 7 on the appropriate side and/or sides of the seal elements 2, 3. This dipping process is advantageous in that it can simplify the step of providing the coating layer 8, 7, thereby improving the working efficiency.

The dipping process may be performed partially or totally. Whether the dipping process should be partial or total may be determined, depending on the particular requirements. For the total dipping process, the coating layer 8, 7 may be formed on the entire side and/or sides of the seal elements 2, 3.

In the encoder-equipped sealing device described above in accordance with the present invention, the seal element 3 may be molded so that the side 31c of the seal element 3 opposite the side on which the seal element 3 is combined with (faces) the seal element 2 can have a rugged surface.

When several units of the encoder-equipped sealing device are placed one over another so that they can be oriented in one particular direction, any two adjacent units 51, 52, for example, are placed such that the encoder 1 in the unit 51 located on the left side may have its right side in FIG. 4 making contact with the side 31c of the unit 52 located on the right side.

In this case, as the seal element 3 in the right-side unit 52 has its side 31c formed to have the rugged surface, the area of contact between the right side of the encoder 1 and the side 31c can be reduced, and the cohesion that may occur between the two units can thus be prevented effectively, even if the coating layer 8 is not formed on the side 31c in the unit 52.

In the case where the side 31c of the seal element 3 in the unit 52 located on the right side is formed to have the rugged surface as described above, the surface treatment liquid can enter the rugged surface on the side 31c when the coating layer 8 is formed by applying the surface treatment liquid onto the side 31c. Therefore, sliding the seal elements 2, 3 relative to each other can be done more easily. Thus, when the metal core 31 in the unit 52 is attached to the encoder 1 in the unit 51 by the magnetic attraction of the encoder 1, the units 51, 52 can be separated from each other easily by simply sliding either of the encoder 1 in the unit 51 or the metal core 31 in the unit 52 in the lateral direction relative to the other.

In accordance with the present invention, the side 31c of the seal element 3 opposite the side on which the seal element 3 is combined with the seal element 2 may also be provided by the flange portion 31b of the metal core 31 as shown in FIG. 3. Alternatively, the elastic seal portion 6 may be extended up to the side 31c of the flange portion 31b so that the seal portion 6 can provide the equivalent function of the side 31c, although this is not shown. In either case, the side 31c may be formed to have the rugged surface. Then, the equivalent function and effect can be provided as described above.

For all of the cases described above, the rugged surface provided on the side 31c of the seal element 3 should preferably have Ra 0.2 to 100 so that the equivalent function and effect as described above can be provided.

In the case where the side 31c of the seal element 3 opposite the side on which the seal element 3 is combined with the seal element 2 is formed by the flange portion 31b of the metal core 31 as shown in FIG. 3, the rugged surface may be provided on the side 31c by roughening the appropriate surface by using the blasting process or chemical process, or by striking the surface or press-molding the surface.

In any of the before-described embodiments, the seal portion 6 may be formed from any elastic materials such as synthetic rubber, synthetic resin and the like, and the annular metal core 21, 31 may be formed from iron or stainless steel materials. The encoder 1 is a multi-pole magnet that may be formed like an annular magnet from a mixture composed of any elastic material such as synthetic rubber, synthetic resin or the like, and any ferromagnetic material such as ferrite, rare earth or the like in its powdery forms. The annular magnet has N polarities and S polarities magnetized alternately around the circumference thereof. The before-described seal portion, annular metal core, and encoder are known and used in the conventional encoder-equipped seal device constructed by incorporating the encoder and seal elements combined together, so that they are mounted on the bearing unit on the automotive vehicle's wheel.

The encoder-equipped sealing devices that have been described in connection with the before described embodiments are used together with a sensor that may be disposed adjacently to and opposite the encoder 1 so that it can detect the pulses that are generated magnetically by the encoder 1. The magnet-based encoder 1 that is located on the seal element mounted on the rotational element on the automotive vehicle is rotated as the rotational element rotates, and the pulses from the encoder 1 rotating as described above are detected by the sensor. Thereby, the number of revolutions is detected by the sensor. It may be understood from the foregoing description that the encoder-equipped sealing device of the present invention has the encoder 1 incorporated therein.

In accordance with the present invention, when the plural units of the encoder-equipped sealing device described above, such as two units 51, 52 as shown in FIG. 4, for example, are placed one over another adjacently to each other so that they are oriented in one particular direction, so that they are oriented in one particular direction, the cohesion between the respective seal elements in the adjacent units 51, 52 that might otherwise be caused by the magnetic attraction coupled with the adhesiveness of the elastic material (usually synthetic rubber or synthetic resin) on which the encoder 1 is based can be avoided effectively.

Then, even if the plural units of the encoder-equipped sealing device are loaded in the magazine, with the units being placed one over the other so that they are oriented in one particular direction, each of the units can be removed from the magazine without being caught by the other units, and can then be mounted securely onto the area that needs to be sealed, such as the appropriate area in the bearing unit.

That is to say, even if the plural units of the encoder-equipped sealing device are placed one over the other so that they are oriented in one particular direction, the encoder-equipped sealing device can be slid relative to the other without causing any problems. Also, either of the two units that are located adjacently can be moved away from the other without causing any problems, so that individual units of the encoder-equipped sealing device can be handled easily after detaching them from each other. Thus, the encoder-equipped sealing device of the present invention can be slid smoothly out of the magazine equipped in the fitting tool, without causing any problems such as being caught or stuck. Thus, the encoder-equipped sealing device can be mounted on the area that needs to be sealed, such as the appropriate area in the bearing unit, with the highest reliability.

Furthermore, when an attempt is made to separate any two adjacent units from each other by detaching the respective seal elements in the units, this can be accomplished easily by simply sliding either of the seal elements in the lateral direction relative to the other because there is the coating layer between the seal elements. This can also be done without damaging the surface of the encoder 1 because the encoder 1 can be handled with safety. Thus, when the encoder-equipped sealing devices are physically mounted on the appropriate area in the bearing unit that needs to be sealed, it can be accomplished more reliably, and the encoder 1 can provide the pulses with higher precision.

### BRIEF DESCRIPTION OF DRAWINGS

FIG. 1 is a cross sectional view illustrating an example of how the encoder-equipped sealing device in accordance with the present invention is mounted on the bearing unit, although some non-critical parts are not shown;

FIG. 2 is a cross sectional view of the encoder-equipped sealing device in accordance with a first embodiment of the present invention, with some non-critical parts not shown;

FIG. 3 is a cross sectional view of the encoder-equipped sealing device in accordance with a second embodiment of the present invention, with some non-critical parts not shown;

FIG. 4 is a cross sectional view illustrating how two units of the encoder-equipped sealing device in accordance with the embodiment of the present invention in FIG. 2 are placed one over the other, one unit being located on the left side and the other unit being located on the right side, so that they are adjacent and oriented in one particular direction, although some non-critical parts are not shown; and

FIG. 5 is a cross sectional view illustrating how two units of the encoder-equipped sealing device in accordance with the prior art are placed one over the other, one unit being located on the left side and the other unit being located on the right side, so that they are oriented in one particular direction, although some non-critical parts are not shown.

### DETAILED DESCRIPTION OF THE INVENTION

Several preferred embodiments of the present invention are now described below by referring to the accompanying drawings.

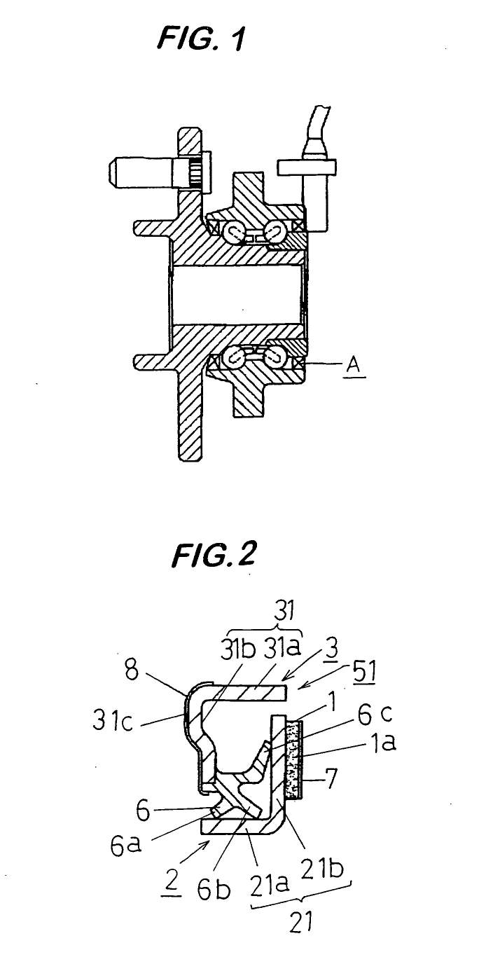

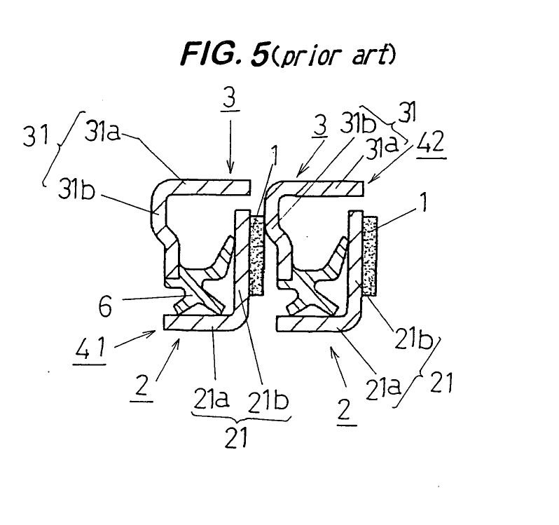

It should be noted that the encoder-equipped sealing device according to the prior art that has been described so far by referring to FIG. 5 and the encoder-equipped sealing device according to the various embodiments of the present invention that will be described below by referring to FIGS. 1 through 4 contain some common parts, elements or members. In the following description, those common parts, elements or members are given the same reference numerals, and are not described to avoid the duplication.

Referring first to FIG. 2, a first unit of the encoder-equipped sealing device according to one embodiment of the present invention, which is identified by reference number 51, is described, wherein a coating layer 8 is formed on the side 31c (located on the left side in FIG. 2) of a first seal element 3 opposite the side on which the seal element 3 is combined with a second seal element 2 (i.e., opposite the side facing the second seal element 2). A coating layer 7 is formed on the side 1a (located on the right side in FIG. 2) of the seal element 2 opposite the side on which the second seal element 2 is combined with the first seal element 3 (i.e., opposite the side facing the first seal element 3).

In the embodiment shown in FIG. 2, the side 31c of the seal element 3 opposite the side on which the seal element 3 is combined with the seal element 2 is formed by the flange portion 31b of a metal core 31, and the coating layer 8 is formed on the side 31c formed by the flange portion 31b of the metal core 31. Although this is not shown, a seal portion 6 may be provided so that it can extend to cover the left lateral side of the flange portion 31b. In this case, the side 31c may be provided by the seal portion 6 that may be made of any elastic material, and the coating layer 8 may be formed on the side 31c of the seal element 3 provided by the elastic seal portion 6.

In the embodiment shown in FIG. 2, an encoder 1 is provided on the side (located on the right side in FIG. 2) of the seal element 2 opposite the side on which the seal element 2 is combined with (faces) the seal element 3, wherein the side 1a of the seal element 2 opposite the side on which the seal element 2 is combined with (faces) the seal element 3 is provided by the right lateral side of the encoder 1. The coating layer 7 is formed on the side 1a, that is, the right lateral side of the encoder 1.

In another embodiment of the present invention, which is not shown, the right side of the encoder 1 as viewed in FIG. 2 may be covered by a metal protective covering. In this case, the side 1a of the seal element 2 opposite the side on which the seal element 2 is combined with (faces) the seal element 3 may be provided by the right lateral side of the metal protective covering, and the coating layer 7 may be formed on that side 1a, that is, the right lateral side of the protective covering.

Each of the coating layers 7, 8 may be formed by applying a surface treatment liquid that will be described below on the respective corresponding sides, that is, the side 31c of the seal element 3 and the side 1a of the seal element 2. The surface treatment liquid may be prepared by dissolving silicone oil in any suitable solution such as chlorofluorosolvate and then mixing the result with any suitable paraffin wax so that the paraffin wax can be distributed uniformly in the solution. The surface treatment liquid can provide the lubricating surfaces for the respective coating layers 7, 8.

FIG. 4 is a cross sectional view illustrating how two units 51 and 52 of the encoder-equipped sealing device in accordance with the embodiment of the present invention in FIG. 2 are placed one over the other, one unit 51 being located on the left side and the other unit 52 being located on the right side, so that they are oriented in one particular direction, although some non-critical parts are not shown.

When the plural units of the encoder-equipped sealing device 51 and 52, such as shown in FIG. 2, are placed one over the other, as shown in FIG. 4, so that they are oriented in one particular direction, the encoder 1 in the unit 51 and the seal element 3 in the unit 52 are separated from each other by the respective coating layers 7, 8 interposed therebetween.

Thus, even when the metal core 31 in the seal element 3 on the unit 52 is attached to the encoder 1 on the unit 51 by the magnetic attraction of the encoder 1, the metal core 31 or encoder 1 may be detached from the other easily by simply sliding either of the two laterally relative to the other. As the respective coating layers 7, 8 are present between the seal element 2 on the unit 51 and the seal element 3 on the unit 52, the cohesion between the two seal elements 2, 3 that would otherwise be caused by the adhesiveness of the elastic material of the encoder 1 can be prevented effectively.

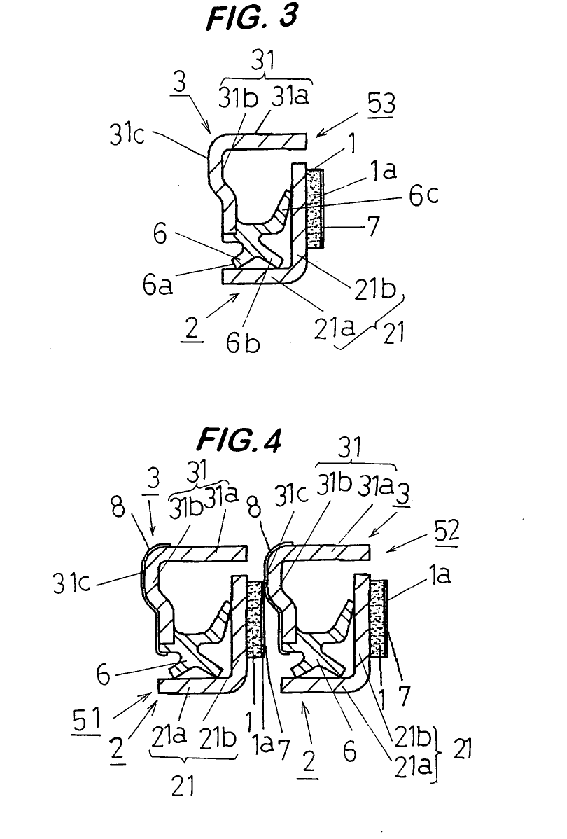

FIG. 3 illustrates the encoder-equipped sealing device 53 in accordance with another embodiment of the present invention. This embodiment differs from the preceding embodiment in that the coating layer 7 is provided on the side 1a of the seal element 2, and no such coating layer is provided on the side 31c of the seal element 3.

It may be seen from FIG. 3 that when plural units of the encoder-equipped sealing device 53, such as two units for example, are placed one over the other so that they are oriented in one particular direction, there is the coating layer 7 between the encoder 1 on the unit located on the left side and the seal element 3 on the unit located on the right side. In this case, even when the metal core 31 in the seal element 3 on the right-side unit is attached to the encoder 1 on the left-side unit by the magnetic attraction of the encoder 1, the metal core 31 or encoder 1 may be detached from the other easily by simply sliding either of the two laterally relative to the other. As the coating layer 7 is present between the seal element 2 on the right-side unit and the seal element 3 on the left-side unit, the cohesion between the two seal elements 2, 3 that would otherwise be caused by the adhesiveness of the elastic material of the encoder 1 can be prevented effectively.

In the embodiment shown in FIG. 3, the side 31c of the seal element 3 opposite the side on which the seal element 3 is combined with (faces) the seal element 2 is provided by the flange portion 31b of the metal core 31. This side 31c may be treated by the blasting process so that it can have a rugged surface of Ra 0.2 to 100.

In this case, when the plural units of the encoder-equipped sealing device 53, such as two units for example, are placed one over the other so that they are oriented in one particular direction, the area of contact between the encoder 1 on the left-side unit and the side 31c of the seal element 3 on the right-side unit can become smaller, and the cohesion between the two elements can thus be prevented effectively.

In each of the embodiments shown in FIGS. 1 through 4, it should be noted that the seal portion 6 includes radial lips 6a, 6b extending from the side, on which the cylindrical portion 31a exists, toward the forward end of the flange portion 31b and in the direction in which the cylindrical portion 31a extends, so that it can extend obliquely, and a side lip 6c extending from the forward end of the flange portion 31b toward the cylindrical portion 31a and in the direction in which the cylindrical portion 31a extends, so that it can extend obliquely.

It should also be noted that when the seal element 3 and seal element 2 are combined such that the space defined by the cylindrical portion 31a and flange portion 31b of the seal element 3 and the space defined by the cylindrical portion 21a and flange portion 21b of the seal element 2 face each other, the radial lips 6a, 6b can abut the circumferential surface of the cylindrical portion 21a, and the side lip 6c can abut the inner surface of the flange portion 21b.

The seal portion 6 may be made of any elastic materials such as synthetic rubber, synthetic resin and the like, as it is known to the art. It should be understood that the present invention is not limited to the embodiments of the seal portion 6 described above by referring to FIGS. 1 through 4.

The encoder-equipped sealing device of the present invention is used by mounting it on the bearing unit of an automotive vehicle, which comprises an inner race and outer race rotating relative to each other, for example.

In each of the embodiments described so far by referring to FIGS. 1 through 4, it is assumed that the seal element 2 in the encoder-equipped sealing device 51 is mounted on the rotational element on an automotive vehicle. For example, the encoder-equipped sealing device according to each of those embodiments has been described, assuming that the encoder-equipped sealing device is mounted on the bearing unit with the seal element 2 in the encoder-equipped sealing device 51 being mounted on the rotational element, such as an inner race. It should be understood, however, that the encoder-equipped sealing device according to each of the embodiments described and shown can be mounted on the bearing unit, comprising an inner race and an outer race relatively rotating each other, by mounting the seal element 2 in the encoder-equipped sealing device 51 on the outer race, which is a rotational element, although this is not shown.

In each of the embodiments described above and shown in FIG. 1 through 4, the encoder 1 is provided on the radial direction across the axial direction. As a variation of those embodiments, the encoder 1 may be provided in the axial direction, which falls within the scope of the present invention. As another of those embodiments, the encoder-equipped sealing device may be constructed such that the respective encoders 1 in any two adjacent units can face each other when they are placed one over the other. In each of those variations, a coating layer may be formed on the surface of the encoder. Thus, the cohesion between the adjacent units that might otherwise be caused by the adhesiveness of the elastic material on which the respective encoders are based can be prevented effectively, and the units that are attached to each other by the strong magnetic attractions of the respective encoders can be detached from each other easily by simply sliding one unit relative to the other in the lateral direction.

Although the present invention has been described with reference to several particular preferred embodiments thereof by referring to the accompanying drawings, it should be understood that the present invention is not limited to those embodiments, and various changes and modifications may be made without departing from the spirit and scope of the invention as defined in the appended claims.

What is claimed is:

1. An encoder-equipped sealing device comprising:
a first seal element including an annular metal core having a substantially L-shaped cross section, said annular metal core having a cylindrical portion and a flange portion on an end of said cylindrical portion, said flange portion extending in a direction perpendicular to an extension direction of said cylindrical portion so as to define a space therebetween;
a second seal element including an annular metal core having a substantially L-shaped cross section, said annular metal core having a cylindrical portion and a flange portion on an end of said cylindrical portion, said flange portion extending in a direction perpendicular to an extension direction of said cylindrical portion so as to define a space therebetween, said first seal element and said second seal element being arranged such that said space of said first seal element faces said space of said second seal element;
an elastic seal portion on said flange portion of said first seal element and arranged in said space of said first seal element;
a magnet-based encoder on said flange portion of said second seal element; and
a coating layer only on an outer side of said flange portion of said first seal element so as to face away from said second seal element.

2. The encoder-equipped sealing device of claim 1, wherein said coating layer comprises a lubricating layer having a lubricating surface.

3. The encoder-equipped sealing device of claim 2, wherein said lubricating layer is made of a surface treatment liquid including a mixture of a solvent and at least one material selected from a group consisting of silicone oil, surface-active agent, wax, and metallic soap.

4. The encoder-equipped sealing device of claim 2, wherein said outer side of said flange portion of said first seal element has a rugged surface.

5. The encoder-equipped sealing device of claim 1, wherein said lubricating layer is made of a surface treatment liquid including a mixture of a solvent and at least one material selected from a group consisting of silicone oil, surface-active agent, wax, and metallic soap.

6. The encoder-equipped sealing device of claim 5, wherein said outer side of said flange portion of said first seal element has a rugged surface.

7. The encoder-equipped sealing device of claim 1, wherein said outer side of said flange portion of said first seal element has a rugged surface.

8. The encoder-equipped sealing device of claim 7, wherein said rugged surface has a surface roughness in a range of Ra 0.2 to Ra 100.

9. An encoder-equipped sealing device comprising:
a first seal element including an annular metal core having a substantially L-shaped cross section, said annular metal core having a cylindrical portion and a flange portion on an end of said cylindrical portion, said flange portion extending in a direction perpendicular to an extension direction of said cylindrical portion so as to define a space therebetween;
a second seal element including an annular metal core having a substantially L-shaped cross section, said annular metal core having a cylindrical portion and a flange portion on an end of said cylindrical portion, said flange portion extending in a direction perpendicular to an extension direction of said cylindrical portion so as to define a space therebetween, said first seal element and said second seal element being arranged such that said space of said first seal element faces said space of said second seal element;
an elastic seal portion on said flange portion of said first seal element and arranged in said space of said first seal element;
a magnet-based encoder on said flange portion of said second seal element; and
a coating layer only on an outer side of said magnet-based encoder on said second seal element so as to face away from said first seal element.

10. The encoder-equipped sealing device of claim 9, wherein said coating layer comprises a lubricating layer having a lubricating surface.

11. The encoder-equipped sealing device of claim 10, wherein said lubricating layer is made of a surface treatment liquid including a mixture of a solvent and at least one material selected from a group consisting of silicone oil, surface-active agent, wax, and metallic soap.

12. The encoder-equipped sealing device of claim 10, wherein an outer side of said flange portion of said first seal element has a rugged surface.

13. The encoder-equipped sealing device of claim 9 wherein said lubricating layer is made of a surface treatment liquid including a mixture of a solvent and at least one material selected from a group consisting of silicone oil, surface-active agent, wax, and metallic soap.

14. The encoder-equipped sealing device of claim 13, wherein an outer side of said flange portion of said first seal element has a rugged surface.

15. The encoder-equipped sealing device of claim 9, wherein an outer side of said flange portion of said first seal element has a rugged surface.

16. The encoder-equipped sealing device of claim 15, wherein said rugged surface has a surface roughness in a range of Ra 0.2 to Ra 100.

17. An encoder-equipped sealing device comprising:
a first seal element including an annular metal core having a substantially L-shaped cross section, said annular metal core having a cylindrical portion and a flange portion on an end of said cylindrical portion, said flange portion extending in a direction perpendicular to an extension direction of said cylindrical portion so as to define a space therebetween;
a second seal element including an annular metal core having a substantially L-shaped cross section, said annular metal core having a cylindrical portion and a flange portion on an end of said cylindrical portion, said flange portion extending in a direction perpendicular to an extension direction of said cylindrical portion so as to define a space therebetween, said first seal element and said second seal element being arranged such that said space of said first seal element faces said space of said second seal element;
an elastic seal portion on said flange portion of said first seal element and arranged in said space of said first seal element;
a magnet-based encoder on said flange portion of said second seal element; and
a coating layer only on both an outer side of said flange portion of said first seal element so as to face away from said second seal element and an outer side of said magnet-based encoder on said second seal element so as to face away from said first seal element.

18. The encoder-equipped sealing device of claim 17, wherein said coating layer comprises a lubricating layer having a lubricating surface.

19. The encoder-equipped sealing device of claim 18, wherein said lubricating layer is made of a surface treatment liquid including a mixture of a solvent and at least one material selected from a group consisting of silicone oil, surface-active agent, wax, and metallic soap.

20. The encoder-equipped sealing device of claim 18, wherein said outer side of said flange portion of said first seal element has a rugged surface.

21. The encoder-equipped sealing device of claim 17, wherein said lubricating layer is made of a surface treatment liquid including a mixture of a solvent and at least one material selected from a group consisting of silicone oil, surface-active agent, wax, and metallic soap.

22. The encoder-equipped sealing device of claim 21, wherein said outer side of said flange portion of said first seal element has a rugged surface.

23. The encoder-equipped sealing device of claim 17, wherein said outer side of said flange portion of said first seal element has a rugged surface.

24. The encoder-equipped sealing device of claim 23, wherein said rugged surface has a surface roughness in a range of Ra 0.2 to Ra 100.

25. An encoder-equipped sealing device comprising:
a first seal element including an annular metal core having a substantially L-shaped cross section, said annular metal core having a cylindrical portion and a flange portion on an end of said cylindrical portion, said flange portion extending in a direction perpendicular to an extension direction of said cylindrical portion so as to define a space therebetween;
a second seal element including an annular metal core having a substantially L-shaped cross section, said annular metal core having a cylindrical portion and a flange portion on an end of said cylindrical portion, said flange portion extending in a direction perpendicular to an extension direction of said cylindrical portion so as to define a space therebetween, said first seal element and said second seal element being arranged such that said space of said first seal element faces said space of said second seal element;
an elastic seal portion on said flange portion of said first seal element and arranged in said space of said first seal element;
a magnet-based encoder on said flange portion of said second seal element; and
a lubricating layer on at least one of an outer side of said flange portion of said first seal element so as to face away from said second seal element and an outer side of said magnet-based encoder on said second seal element so as to face away from said first seal element, said lubricating layer having a lubricating surface.
